(19) United States
(12) Patent Application Publication
(10) Pub. No.: US 2002/0178139 A1
(43) Pub. Date: Nov. 28, 2002

(54) Virtual shared databases

(76) Inventors: Jeane S. Chen, San Diego, CA (US); Ephraim Feig, San Diego, CA (US); Dahlia P. Bona, San Diego, CA (US); Gregory J. Gould, Encinitas, CA (US); Harry E. Gruber, Rancho Santa Fe, CA (US)

Correspondence Address: KINTERA INC., 9605 SCRANTON ROAD, SUITE 240, SAN DIEGO, CA, 92121, US

(21) Appl. No.: 09/819,358

(22) Filed: Mar. 28, 2001

(51) Int. Cl. G06F 7/00

(52) U.S. Cl. 707/1

(57) ABSTRACT

A system and method for analyzing a database residing in a computer system linked to a network is provided. The method includes creating one or more virtual data islands partitioned inside the database, each virtual data island storing client data for a specific client engaged in a fundraising campaign, the client data containing one or more constituent records (CR). The method further comprises the steps of creating a master island containing a compilation of the fields in the virtual data islands. The method further comprises the steps of creating a linking table including a compilation of unique identifiers of the individuals whose records are in the virtual data islands. The method further comprises the steps of creating a data pool having selected data from the CRs, analyzing the data pool, and using the results of the analysis in fundraising campaigns. The method further comprises identifying potential donors from the results of the analysis. The method further comprises determining, from the results of the analysis, a probability of a charitable donation by an individual donor. The method further comprises accessing individual donor records online, and conducting financial transactions.

### FIELD OF THE INVENTION

The present invention relates to database systems. More specifically, the invention relates to virtual shared databases where client data stored in a data repository is analyzed, and the analysis results are shared among participating clients.

### BACKGROUND OF THE INVENTION

In a relational database system, many individual records of data are stored in tables. Each table identifies fields, or columns, and individual records are stored as rows, with a data entry in each column. For example, in an employment database, there may be a table EMPLOYEES which comprises fields, or columns, such as employee ID, last name, first name, address, city, state and so forth. One record, including data in the several columns, would be entered in the EMPLOYEE table for each employee. Similarly, other tables would be established in accordance with the logical schema of the database. For example, a table SALARY HISTORY may include columns of salary history information, with each record being identified by an employee ID. Another table MANAGERS may include columns identifying information specific to managers and may also include the employee ID field. Relations between tables can be established by reference to the columns that appear in multiple tables, such as employee ID in the above example.

A table in a database, for example, may include several rows and three columns, the entries in the first column being names of employees of a company, the entries in the second column being the monthly salaries of the employees, and the third column being the product of the entries of the second column and 12, representing the annual salaries of the employees. Any change in an entry in the second column would automatically induce a change in the corresponding entry of the third column.

Consider the above example where the table may have a fourth column whose entries are the job-description titles of the employees. A relational database could be built by adding to this table a second table with, say, several rows and three columns, the first containing all the job-description titles defined by the company, the second containing the actual job-description, and the third containing the salary range for the job-description. The two tables in the database are not independent; the job-description titles in both tables are the same set of entries representing the same job-descriptions.

A database management system application may comprise a database server and several client systems. The database is housed in the database server, together with various applications for manipulating the data in the database. The database server can accept requests from any of the various client systems. The database management system manages the integrity of the data and handles conflict resolution whenever various clients seek to transact with the data simultaneously. Other database management system applications handle issues related to data integrity, security and privacy of data. For example, applications for rights-management allow database administrators to assign various access rights to various people. For example, Web users who come to an online store may have viewing access and see items for sale and their prices, but only shoppers who have previously registered with the online store and have been provided a user identification name and a password may have shopping access, which means a rights access to interact with the database with an actual buy transaction. Similarly, only a select group of employees of the online store may have access to the shopping history for the entire store, and perhaps a subset of these employees will have rights to edit that history or to use the history data for analysis or for marketing purposes.

Using the above example, the rows of the first table may be alphabetically ordered by the names of the employees. The rows of the second table may be ordered using alphabetical ordering of the job-description titles. If one were to observe where in the salary scale a certain employee belongs, an algorithm running on the database would easily find the employee by searching the first table using the alphabetical ordering of the name, then locating the employees job-description title, and then searching for the salary range in the second table, again using an alphabetical ordering. The algorithm could then compare the employee's salary with that of the salary range for that employee's job description.

Databases can become very complex, comprising millions thousands of tables and billions of entries. Typically organizations, such as a store or a charitable organization, house data that relate to their own businesses. However, as databases become increasingly complex, these organizations often find it difficult to manage and maintain such large databases.

In order to address this problem, some application service providers (ASPs) have emerged to service and maintain the databases of client organizations. These ASPs provide efficient and reliable service related to client database management, and clients are increasingly relying on their expertise for the maintenance of their data.

For example, an ASP may specialize in the handling of information or data of charitable organizations. Such an ASP will host a large database, also referred herein as a data warehouse, comprising a plurality of client databases, each client database representing the data of a client organization. An application software runs on top of each of the client databases. The client databases of the individual client organizations can be considered as virtual islands of information. To ensure privacy of the clients' data, no data is allowed to pass from one island to another.

However, in some cases, it is often desirable to share information among various clients whose databases are hosted in one large data-warehouse. It is further desirable that the sharing of such information be compliant with the clients' wishes of what type of information is shared and with whom it is shared.

Furthermore, it is sometimes desirable that only metadata derived from the actual data of various clients be made available for sharing. For example, clients may be willing to share information regarding correlations among various shopper traits and buying habits but not any specific buying data. This may be especially true when a client realizes that sharing metadata obtained from just one client in return for gaining insight by performing analysis on metadata from numerous clients can be advantageous. It is further desirable that the clients have some convenient way of indicating the conditions under which their data can be used either for sharing or to generate metadata for sharing. It is also sometimes desirable that the individuals whose personal information comprises the data in a data warehouse have the ability to designate whether or not their personal data should be part of a data-sharing mechanism as indicated above.

### SUMMARY OF THE INVENTION

In accordance with one embodiment of the invention, there is provided a method for analyzing a database residing in a computer system linked to a network, the computer system having one or more processors, and one or more storage devices coupled to the processors. The method comprises the steps of creating one or more virtual data islands partitioned inside the database, each virtual data island storing client data for a specific client engaged in a fundraising campaign, the client data containing one or more constituent records (CR). The method further comprises the steps of creating a master island containing a compilation of the fields in the virtual data islands. The method further comprises the steps of creating a linking table including a compilation of unique identifiers of the individuals whose records are in the virtual data islands. The method further comprises the steps of creating a data pool having selected data from the CRs, analyzing the data pool, and using the results of the analysis in fundraising campaigns.

The method further comprises identifying potential donors from the results of the analysis. The method further comprises determining, from the results of the analysis, a probability of a charitable donation by an individual donor. The method further comprises accessing individual donor records online, and conducting financial transactions.

### BRIEF DESCRIPTION OF THE DRAWINGS

These and other features of the invention will now be described with reference to the drawings summarized below. These drawings and the associated description are provided to illustrate various embodiments of the invention, and not to limit the scope of the invention.

FIG. 1 illustrates an example embodiment of the database in accordance with the invention.

FIG. 2 is a basic flow diagram of a method for creating a database in accordance with one embodiment of the invention.

### DETAILED DESCRIPTION OF THE INVENTION

The present invention provides a solution to the above-mentioned problems using a novel database structure. Briefly stated, the invention provides a database structure, referred herein as a data warehouse, which hosts databases of one or more client organizations. In other words, the data warehouse comprises one or more client databases. The invention allows sharing of client proprietary information, i.e., client proprietary data, among various client organizations participating in the data warehouse. The data warehouse can be maintained and managed by an Application Service Provider (ASP) or any other organization for the benefit of one or more client organizations.

In one aspect, the invention provides a quid-pro-quo to the client organizations. The client organizations agree to share selected proprietary data with others in the data warehouse. The shared data is then analyzed to extract valuable information that can benefit the client organizations. The analysis is performed by the ASP or other organizations. In exchange for providing the selected data for analysis, the client organizations gain access to the results of the analysis. The client organizations can use the results of the analysis for their own benefit. For example, the results of the analysis can be used by the individual client organizations in their marketing strategy, i.e., more effectively target consumers.

The client organizations choose whether to share information with other clients, what type of information to share and with whom to share. The invention provides various opt-in features by which a client decides how to participate in the data sharing scheme. The invention preserves the integrity of client data by ensuring secrecy of the data and by allowing the client to maintain ultimate control over the data. To address the privacy concerns, in one embodiment, sensitive client data is handled by designated persons only.

In one embodiment, only meta data derived from the actual data of various clients are made available for sharing. The clients gain valuable insight from analysis performed on meta data of other clients. The clients also have a convenient way of indicating the conditions under which their data can be used either for sharing or for generating metadata.

In one embodiment, the clients are nonprofit organizations (NPOs) such as charitable organizations. The NPOs conduct online and offline fundraising and support various charitable causes. The NPOs maintain a database that stores donor and constituent data. The data includes personal data as well as transactional data.

The databases are housed in the data warehouse maintained by an ASP. The data warehouse includes many virtual data islands, each virtual data island housing data of an NPO. In one embodiment, the data warehouse resides in one database server. The NPOs as well as their contacts, donors, volunteers, board members, associates, and event participants can access the database server via the Internet.

In one embodiment, the data of various virtual data islands resides in one physical device such as a disk drive, but they are virtually partitioned with a database table attribute called NPO_id. Individuals whose records make up the databases of the various NPOs share a common unique identifier across the various virtual data islands. A linking table includes a compilation of unique identifiers of individuals whose records make up the databases together with information regarding which of the various data islands contain information about these individuals. The linking table is updated each time a new individual is added to any of the component database islands.

The following is an example of the creation of a linking table from two virtual data islands. A first virtual data island is called Island_{—}1 and is illustrated below:

| Island_1 | | | |
|---|---|---|---|
| Name | Unique_Id | Telephone | Male/Female |
| George Smith | 1234 | 444-1234 | M |
| Henry Smith | 1235 | 555-4321 | M |
| John Doe | 1236 | 777-9534 | M |
| Martin Lewis | 1237 | 666-8424 | F |

A second virtual data island is called Island_{—}2 and is illustrated below:

| Island_2 | | | |
|---|---|---|---|
| Name | Unique_Id | Telephone | Male/Female |
| George Smyle | 1334 | 555-9234 | M |
| Linda Smyle | 1335 | 666-9321 | F |
| John E. Doe | 1236 | 777-9534 | M |
| Mary Land | 1337 | 666-5424 | F |

The linking table is then created from the two virtual data islands:

| Unique_Id | Data Island List |
|---|---|
| 1234 | 1 |
| 1235 | 1 |
| 1236 | 1, 2 |
| 1237 | 1 |
| 1334 | 2 |
| 1335 | 2 |
| 1337 | 2 |

The linking table lists the individuals who are entries in any of the virtual data islands that are identified by the unique identifiers. Note that the unique identifiers for John Doe in Island_{—}1 and John E. Doe in Island_{—}2 are the same. This is because both John Doe and John E. Doe are the same person, but are using two slightly different names in the two tables.

The linking table is important because it speeds various database functions such as searching for records. For example, suppose we want to find all the information in the data warehouse about George Smith, whose unique-Id is 1234. Without a linking table, we would have to search for George Smith in every virtual island. There may be thousands of virtual islands, but only few with any information about George Smith. Rather than searching the thousands of islands, one can determine from the linking table those islands that contain information about George Smith and then search for that information only at those islands. This can significantly speed up the search process.

In one embodiment, the virtual data islands include an opt-in field that indicates whether or not the client wishes to participate in a particular data-sharing scheme. An opt-in field is a field in the database that is set and updated as desired by a representative of the client with write-access to that field, via an application program. The term opt-in refers to the client's selection of an option to participate in the scheme.

Another embodiment allows the opt-in field to accept a multi-valued variable, each value corresponding to some particular data-sharing scheme. In this way, different clients may choose to share their data with others in different manners. The particulars of the manners of sharing information are described in a web page that is accessed by the client.

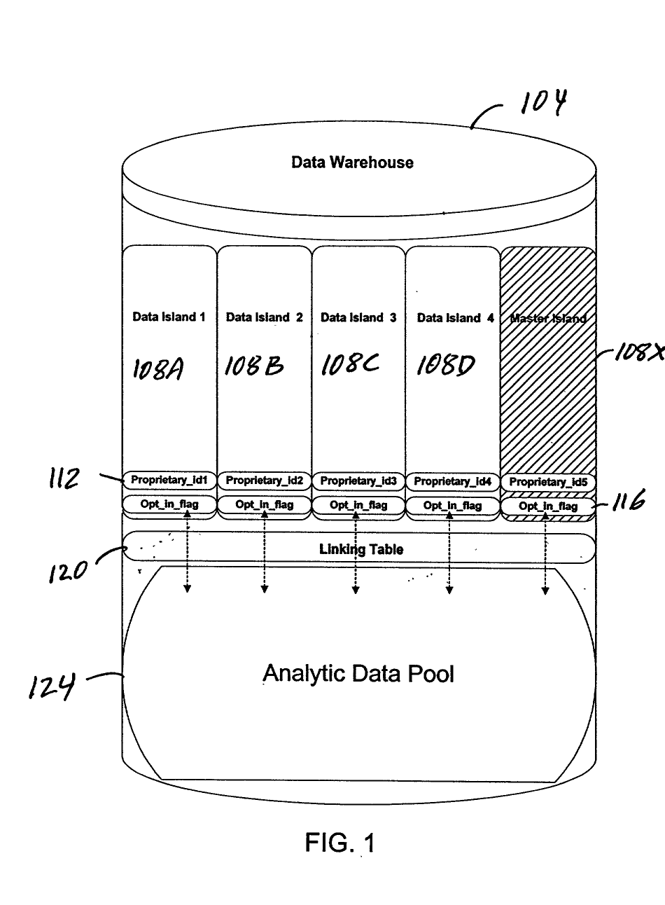

FIG. 1 illustrates an example embodiment wherein an ASP maintains a centralized data repository or a data warehouse 104. The data warehouse 104 retains client proprietary information. More specifically, in this example, the data warehouse 104 retains a plurality of nonprofit organizations' (NPOs) donor (or supporter) information in four virtual data islands 108A-108D. Each virtual data island 108 retains data of a particular organization. Each data island includes individual donor records.

In this particular embodiment, the data warehouse also contains a derived data island 108X also referred to as a master island. The master island 108X contains a compilation of various fields from all the entries in all the other data islands. For example, the various data islands may contain donor profile information like name, address, phone number, and unique_id, and transactional information like donation history and event participation history. The master island 108X contains a compilation of profile information of all donors in all the other islands.

The information may include donation information, transactional information, and any other information related to the constituent or one or more fundraising or charitable causes and/or events. The donor information also includes web-based data such as, for example, donations received during a fundraising event and made through a web-based system. Off-line event's data are entered into the database via administrative tools.

As illustrated in FIG. 1, individual NPO's virtual data islands and their records are virtually partitioned by an attribute called proprietary_id 112, which establishes the privacy boundaries in the record sets. In one embodiment, every organization has a unique identification tag, a string of letters and numbers that is unique to the organization. It may be the name of the organization, or some number that an ASP assigns to the organization, or some other unique tag. Any data that is linked to the unique tag belongs to the organization to whom that unique tag is associated. This privacy attribute allows for clear delineation of ownership and access, thus enabling an organization's data to be isolated and detached from other organization's data. These organizations may be charitable organizations, nonprofit organizations or any other type of organizations.

The virtual data islands 108 include an opt-in field 116 that indicates whether or not the client wishes to participate in a particular data-sharing scheme. In one embodiment, the opt-in field 116 is set and updated as desired by the client (or its representative) with write-access to that field, via an application program. The term opt-in refers to the client's selection of an option to participate in the data-sharing scheme.

In one embodiment, the virtual data islands include an opt-out field (not illustrated in FIG. 1) that is similar to the opt-in field. If a client wishes to participate in the data sharing scheme but does not wish to share certain selected data, the client can utilize this feature. The opt-out field allows a participating client to indicate what data the client would not share. In other words, the opt-out field allows a client to participate in the data sharing scheme but allows it to withhold certain selected data from being disclosed and shared.

Referring back to FIG. 1, a linking table 120 includes a compilation of selected fields from the individual donor records. The linking table 120 is updated each time a new donor record is added or a donor record is removed.

The data in the data islands 108 are analyzed or otherwise examined and the analysis results stored in the analytic data pool 124 are made available to the client organizations. The client organizations use the data in the analytic data pool 124 in various aspects of their business, including marketing and strategic planning.

An individual, e.g., a donor, may be affiliated with one or more organizations. Being affiliated with an organization typically means that the organization has profile data about the individual. Different organizations may have different profile data about the same individual. As described in the example above, the individual with the unique_id 1236 has given slightly different names to each of the two organizations whose data are stored in island_{—}1 and island_{—}2, respectively. In island_{—}1 he is known as John Doe, whereas in island_{—}2 he is known as John E. Doe.

A donor, aside from being affiliated with various organizations that are the ASP's customers, may also be an ASP member. Membership in the ASP allows donor's profile data updates to be posted on an ASP's master database. The retention of this master database provides the capability to propagate changes as needed and as permitted. Using the previous example, John Doe may decide that the name he would like to have associated with all organizations affiliated with the ASP is John E. Doe. By being a member of the ASP, he may have the option of automatically updating the fields in all data islands corresponding to organizations that he is a member of so that they are all consistent. In this example, the field in island_{—}1 would be updated from John Doe to John E. Doe. Often the various organizations allow their constituents access to some data in their respective data islands, but require some user-id and password in order to gain this access. The automatic update feature just describes enable a constituent to have one user-id and password valid for all the organizations represented within the data warehouse.

In one embodiment, the data sharing option allows the client's proprietary data to be part of a larger data set comprising of all data belonging to all clients who have opted in for this option. The larger data set is used for statistical analysis and data mining purposes. The results of the analysis and mining that give no particular information regarding any single individual or a client organization is shared.

Using the example of a database comprising the two islands, Island_{—}1 and Island_{—}2, one may infer from both that the telephone number of a female starts with 666. This may not be true in general, but it is true when restricted to the given data. While it is true for the data in Island_{—}1, it may not be sufficient to give confidence that this is true in general. However, since the fact is confirmed by all three examples in both islands, that increases the confidence level of the inference.

Another example of such information is the compilation of the likelihood of a donation during various time periods within the first several days after a fundraising event. For example, a first island may contain data about a race for a charity event, and the data may indicate that most donations occur during the evening hours of the two-week time interval prior to the race and are made by young people. A second island may contain data about a gala dinner fundraising event, and the data may indicate that most donations are uniformly spread over a one-month period during the evening hours and are made by older people. Thus, it can be inferred that, for event-based fundraising, younger people tend to delay donating more than older people, and that donations are generally made in the evening hours. Referring to FIG. 1, a computer program can perform statistical analysis on data in island 108A, computing the time and age distributions of donations and donors, respectively, for a charity race. The computed distribution is stored in the analytic data pool 124. Another computer program can perform statistical analysis on data in island 108B, computing the time and age distributions of registrations and registrants, respectively, for a gala dinner event and again stores its computed distribution in the analytic data pool 124. A third program then analyzes on the combined data in the data pool 124 to reach various conclusions. Such information can be valuable to NPOs engaged in direct mail campaigns, since it suggests when to send out mailings. Furthermore it can be of value in timing telephone calls, since the potential donors can be reached when they are most likely to donate. The statistics will be shared among those who opt in to share.

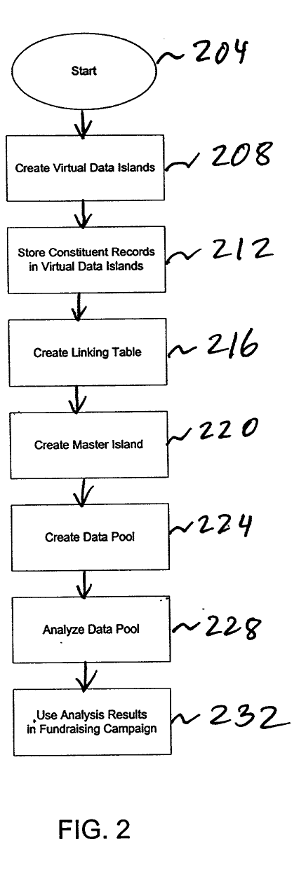

FIG. 2 is a basic flow diagram of a method for creating a database to be used in one or more fundraising campaigns in accordance with one embodiment of the invention. The database resides in a computer system that is linked to a network such as the Internet.

The flow starts at step 204, and moves to step 208 where one or more virtual data islands are created in a database. In step 212, client data having one or more constituent records (CRs) is stored in the virtual data island. The constituent records can be individual donor records. Each virtual data island stores data belonging to a specific client engaged in one or more fundraising campaigns.

In step 216, a linking table is created from the CRs. The linking table includes a compilation of unique identifiers of individuals whose records make up the databases together with information regarding which of the various data islands contain information about these individuals. In step 220, a master island is compiled from the CRs. The master island contains a compilation of various fields from all the entries in all the other data islands.

In step 220, an analytic data pool is created. The analytic data pool includes data that the clients or individuals have agreed to share. The analytic data pool is created based on the opt-in flags and optionally the opt-out flags. In step 224, the analytic data pool is analyzed. In step 228, the results of the analysis are used in the fundraising campaigns.

In one embodiment the invention provides an automatic update option. With this option, a client allows the automatic update of certain fields if the corresponding fields in another client who also opted it are updated. Consider, for example, that a donor has provided his address to both client organizations A and B, and that both A and B have opted in for this option. If the donor updates his address on A's database, the system automatically detects this updates, verifies that both A and B have opted-in for the option, and then automatically updates the address of the donor in B's database.

In another embodiment, the automatic update option described above is only provided when both client organizations and the individual donor opt-in.

In another embodiment, the invention includes an automatic notification of an update option. With this option, the clients opt in to participate in an automatic notification program, wherein when certain fields in one participating client's database are updated, a notification will be sent to all other participating clients who have a field corresponding to the one updated that the field has been updated. Whereas in the previous example these corresponding fields were automatically updated, in this embodiment the clients are notified of the update and can choose whether or not to perform the update in their respective databases. Consider, for example, that a donor has changed his or her address on record for organization A. The system verifies that the donor has opted-in for updating at both organizations A and B and that the donor also gave her email address to organization B. The system then automatically emails to the organization a notification of the change of address. Organization B can then decide whether or not to update the address record for the donor.

In another embodiment, a master database not only contains data of the master table, but all attributes of donors, such as addresses, phone numbers, email addresses, credit card information, and transaction histories of all the virtual islands. A client organization can opt-in for participation in updates via access to the master database, and can further select which entries will be available for updates. When a donor updates a field in the database of a participating client, a record of the update is also made in the master database if that field is contained in the master database. All clients that have opted in for this option have access to entries of the master database for which donors have provided data in their respective individual databases. For example, if a donor did not give his phone number to client A, then client A will not have access to that donor's phone number data in the master database. In this way, clients can update entries in their databases for the donors that have already provided information to them, and the system need not be burdened with sending out notifications.

In another embodiment, the donors opt in for participation in data sharing in any of the various forms described above. Thus, while the client organizations may have opted in for data sharing, they would only share data regarding those donors who have also opted in for such data sharing.

In another embodiment, members of various organizations (i.e., individuals) have login capabilities. The members access the data that is stored in the organization's island database and perform other functions and transactions. It is advantageous for a particular donor to have identical login information, such as username and password, for all the organizations that the donor is a member of. In one embodiment, individuals can become members of a virtual organization set up by the ASP that is hosting the database islands and functions associated with them of the various organizations. The ASP controls and owns the master database, and may give their members login access to such data that the organization may allow them to see or manipulate.

In one embodiment, the program code for carrying out the steps in accordance with the present invention can be stored in a storage medium and made available for sale as a software program or a computer program product. For example, the program code can be stored in a compact disk (CD), a magnetic tape, or any other type of storage medium. A manufacturer can make the software program available for sale so that ASPs, individuals and business entities may purchase or otherwise obtain the software program to set up a database system in accordance with the present invention.

Although the preferred embodiments have been described, it should be understood that various changes, substitutions, and alterations can be made herein without departing from the scope of the present invention. It should be understood that the application of the present invention is not limited only to fundraising campaigns. Rather, the present invention can be implemented to perform all forms of transactions and in any other type of business activities over a wide area network that will be apparent to those skilled in the art. For example, the database disclosed herein can be used by other organizations that are engaged in activities unrelated to fundraising campaigns.

Furthermore, it should be noted that the present invention can be implemented using virtually any computer system or other networking system and virtually any available programming language. Other examples of changes, substitutions, and alterations are readily ascertainable by one skilled in the art and could be made without departing from the spirit and scope of the present invention as defined by the following claims.

What is claimed is:

1. A database in a computer system linked to a network and configured to store client data, the computer system having one or more processors, one or more storage devices coupled to the processor, the storage device having stored the database system, comprising:
one or more virtual data islands partitioned inside the database, each virtual data island storing client data for a specific client engaged in a fundraising campaign, the client data containing one or more constituent records (CR);
a data pool having selected data from the CRs; and
one or more program code for analyzing the data pool.

2. The database as recited in claim 1, wherein the results of the analysis are used in fundraising campaigns.

3. The database as recited in claim 1, further comprising a master island containing a compilation of the fields in the virtual data islands.

4. The database as recited in claim 1, further comprising a linking table including a compilation of unique identifiers of the individuals whose records are in the virtual data islands.

5. The database as recited in claim 1, wherein the network is the Internet.

6. The database as recited in claim 1, wherein the network is a wide area network.

7. The database as recited in claim 1, wherein the client is a nonprofit organization (NPO).

8. The database as recited in claim 1, wherein the client is a person.

9. The database as recited in claim 1, wherein the results of the analysis are used to identify potential donors likely to donate to one or more charities.

10. The database as recited in claim 1, further comprising an opt-in field indicating whether or not a client is participating in a data-sharing scheme.

11. The database as recited in claim 1, further comprising a program code configured for statistical analysis of the data pool.

12. The database as recited in claim 9, further comprising program codes for determining a probability of a charitable donation by an individual donor.

13. The database as recited in claim 10, wherein the opt-in field is set and updated with write-access to the field.

14. The database as recited claim 10, wherein the opt-in field accepts a multi-valued variable, each value corresponding to a data-sharing scheme.

15. The database as recited in claim 14, wherein the multi-valued variable allows clients to share data with others in different manners.

16. The database as recited in claim 1, further comprising means for automatically updating fields in a virtual data island if corresponding fields in other virtual data islands are updated.

17. The database as recited in claim 16, further comprising means for automatic notification of an update option, wherein when fields in one client's virtual data island is updated, a notification is sent to other participating clients that have a corresponding field.

18. The database as recited in claim 1, further comprising means for login access for donors to the individual donor records in the virtual data islands, wherein the donors access their records and conduct financial transactions online.

18. The database as recited in claim 1, wherein the client is a charitable organization.

19. The database as recited in claim 1, wherein the client is a political organization.

20. The database as recited in claim 1, further comprising a common identifier shared by the individual donor records across the virtual data islands.

21. The database as recited in claim 1, further comprising an opt-out field that indicates the data the client does not wish to share.

22. A method for analyzing a database residing in a computer system linked to a network, the computer system having one or more processors, one or more storage devices coupled to the processors, comprising:
creating one or more virtual data islands partitioned inside the database, each virtual data island storing client data for a specific client engaged in a fundraising campaign, the client data containing one or more constituent records (CR);
creating a data pool having selected data from the CRs; and
analyzing the data pool.

23. The method as recited in claim 22, further comprising using the results of the analysis in fundraising campaigns.

24. The method as recited in claim 22, further comprising creating a master island containing a compilation of the fields in the virtual data islands.

25. The method as recited in claim 22, further comprising creating a linking table including a compilation of unique identifiers of the individuals whose records are in the virtual data islands.

26. The method as recited in claim 22, wherein the network is the Internet.

27. The method as recited in claim 22, wherein the network is a wide area network.

28. The method as recited in claim 22, further comprising identifying potential donors from the results of the analysis.

29. The method as recited in claim 22, further comprising determining, from the results of the analysis, a probability of a charitable donation by an individual donor.

30. The method as recited in claim 22, further comprising:
accessing individual donor records online; and
conducting financial transactions.

31. The method as recited in claim 30, wherein the financial transaction includes making a donation to one or more organizations.

32. The method as recited in claim 22, wherein the client is a nonprofit organization (NPO).

33. The method as recited in claim 22, wherein the client is a charitable organization.

34. The method as recited in claim 22, wherein the client is a political organization.

35. A computer-readable medium having computer-executable instructions for performing a method for analyzing a database residing in a computer system linked to a network, the computer system having one or more processors, one or more storage devices coupled to the processors, comprising:
creating one or more virtual data islands partitioned inside the database, each virtual data island storing client data for a specific client engaged in a fundraising campaign, the client data containing one or more constituent records (CR);
creating a data pool having selected data from the CRs;
creating a master island containing a compilation of the fields in the virtual data islands;
creating a linking table including a compilation of unique identifiers of the individuals whose records are in the virtual data islands; and
analyzing the data pool.

36. A method for creating a database residing in a computer system linked to a network, the computer system having one or more processors, one or more storage devices coupled to the processors, comprising:
creating one or more virtual data islands partitioned inside the database, each virtual data island storing client data for a specific client engaged in a fundraising campaign, the client data containing one or more constituent records (CR);
creating a master island containing a compilation of the fields in the virtual data islands;
creating a linking table including a compilation of unique identifiers of the individuals whose records are in the virtual data islands; and
creating a data pool having selected data from the CRs;
